(19) United States
(12) Patent Application Publication
(10) Pub. No.: US 2026/0257447 A1
(43) Pub. Date: Sep. 3, 2026

(54) Arrangement for Producing Layer Adhesion of at Least Two Tissue Layers by Means of Cold Welding

(71) Applicants: Matthews International GmbH, Vreden (DE); Matthews International Corporation, Pittsburgh, PA (US)

(72) Inventors: Christof RÖRING, Vreden (DE); Heinz WITTEBROCK, Ahaus (DE); Frank LAUKAMP, Gronau-Epe (DE)

(21) Appl. No.: 18/864,613

(22) PCT Filed: May 12, 2023
(86) PCT No.: PCT/DE2023/100351

§ 371 Date: Nov. 11, 2024

(30) Foreign Application Priority Data
May 12, 2022 (DE) 10 2022 111 873.8

(51) Int. Cl. B31F 1/07

(52) U.S. Cl. CPC B31F 1/07; B31F 2201/073; B31F 2201/0733; B31F 2201/0738; B31F 2201/0748; B31F 2201/0761; B31F 2201/0776; B31F 2201/0789

(57) ABSTRACT

The invention relates to an arrangement (1) for producing a layer adhesion of at least two tissue layers (2) by means of cold welding, wherein the arrangement has two rollers (4) forming an embossing gap (3) for connecting the tissue layers (2), wherein at least one of the rollers (4) has an embossing plate (6) detachably fastened to the roller surface (5) on its roller surface (5) facing the embossing gap (3), wherein the embossing plate (6) has an embossing structure (7), characterized in that the embossing plate (6) is fastened to the roller (4) by means of a plurality of magnets (8) distributed over the roller surface (5) and arranged at a distance from one another.

The invention relates to an arrangement for producing a layer adhesion of at least two tissue layers by means of cold welding, wherein the arrangement has two rollers forming an embossing gap for connecting the tissue layers, wherein at least one of the rollers has on its roller surface facing the embossing gap at least one embossing plate detachably fastened to the roller surface, wherein the embossing plate has an embossed structure.

From WO 2016/169574 A1, an embossing plate for fastening to a cylinder of an embossing device is known, wherein the embossing plate has a steel layer, an upper side and a lower side and can be used for embossing flat materials. The publication reveals that the entire cylinder surface for attaching the embossing sheets is itself magnetic. The device therefore has the disadvantage that a compromise must be made when using a suitable material for the cylinder surface, which on the one hand takes into account a cost-effective and durable cylinder material and on the other hand a material with good magnetic properties. Furthermore, if the cylinder is damaged, it is necessary to replace it completely.

A sleeve-change calender is known from EP 1 967 360 A2. This has as its base a roller core that remains in a calender frame during a sleeve change and on which different sleeves can be clamped. The sleeves are designed as cylindrical hollow bodies which are pushed onto or removed from the roller core in the axial direction of the latter. After being pushed onto the roller core, the sleeve is tightened using a clamping tool so that the sleeve is secured to the roller core in a twist-proof manner. The disclosed arrangement has the advantage that the sleeves can be exchanged depending on the application, so that for different applications, not complete rollers but only different sleeves have to be kept in stock.

However, no calender using an embossing sheet is known from the state of the art, which on the one hand can be produced cost-effectively and on the other hand has improved functional properties.

It is therefore the object of the invention to improve a sleeve-changing calender in such a way that it can be adapted inexpensively and flexibly to different applications while requiring little machine downtime.

The object is achieved by the features of the independent claims. Advantageous embodiments are described in the respective dependent claims.

Accordingly, it is provided that the embossing plate is fastened to the roller by means of a plurality of magnets distributed over the roller surface and arranged at a distance from one another.

It can be provided that the magnets are releasably received in grooves distributed over the circumference of the roller and spaced apart from one another. The magnets or the grooves can be designed in such a way that they are aligned with the roller surface.

Furthermore, it can be provided that the grooves and the magnets accommodated therein extend substantially in an axial direction of the roller. The grooves can each extend over the entire width of the roller. Accordingly, the magnets accommodated in the grooves can extend over the entire width of the roller.

It is also conceivable that the grooves are undercut and open into the axial end faces of the roller body, so that the magnets can be mounted or dismounted in the grooves in the axial direction of the roller. Alternatively, it is conceivable that the magnets can be inserted into or removed from the grooves in a radial direction. In this case, the magnets can be glued and/or screwed into the grooves.

It can be provided that the magnets comprise a permanent magnetic material, for example iridine or neodymium, by means of which the at least one embossing sheet is attached to the sleeve. Attaching the embossing sheets to the sleeves using magnetism allows for easy handling. Since the embossing sheets also contain a magnetic material, they can be attached to the magnetic sleeve through magnetic interaction. This fastening without additional fastening elements means that the embossing plate can be changed more quickly. Furthermore, no additional installation space needs to be provided for these fastening devices. The roller core and/or the sleeve can be made of a suitable non-magnetic steel. This allows an ideal combination of strong magnetic material for the magnets and a cost-effective and durable material for the roller core and/or the sleeve to hold the magnets.

Furthermore, it can be provided that the at least one roller having the embossing sheet has a roller core and a sleeve detachably fastened to the roller core and enclosing it, so that the roller surface is provided by the sleeve.

The sleeve can be connected to the roller core in a frictional manner, in particular by shrinking the sleeve and/or extending or expanding the roller core. The embossing sheet can be attached to the sleeve by the plurality of magnets distributed over the surface of the sleeve and arranged at a distance from one another. The sleeve can have a material thickness of >3 mm. The roller core can be made of a metal material that is softer than the sleeve.

This reduces the machine downtime required to change the embossing plates by allowing the old embossing plate to be dismantled, the new embossing plate to be installed and the new embossing plate to be set up outside the machine on a separate sleeve. The arrangement therefore has the advantage that it enables the embossing plates to be changed outside the calender or parallel to a process running in the calender. In addition to the preparation of the sleeves outside the machine, which includes dismantling a used embossing plate from a previous embossing process, assembling a new embossing plate for a subsequent embossing process and setting it up, e.g., aligning the embossing plate on the sleeve and/or checking concentricity, the invention has the advantage over the prior art that only a small number of sleeves have to be kept in stock in order to produce a large number of different embossing structures in different embossing processes, since the different embossing structures can be realized by using different embossing plates. For example, two sleeves can be provided, one of which is located in the machine and the other outside the machine is prepared for the next embossing process. Three or more sleeves can also be provided so that the third sleeve can also be prepared during the sleeve change. At the same time, it is not necessary to replace and set up the embossing plates on the permanently installed roller, since the present invention allows the embossing plates to be replaced and set up outside the machine and therefore the machine downtime can be minimized. If required, the sleeve can of course also be loaded inside the machine.

The arrangement also has the advantage that it can be used cost-effectively and flexibly to generate layer adhesion between at least two tissue layers. The advantage is in particular that the arrangement can be quickly and cost-effectively converted from the production of a first tissue embossing pattern to a different embossing pattern. By “cold welding” under high embossing pressure, sufficient layer adhesion can be achieved. Cold welding, which is mainly used to join metal workpieces, means that two or more layers of the same material are joined together at room temperature in such a way that they adhere to one another and at least come close to being glued together.

The patent protection is aimed at applications in the tissue sector, where compression and thus the connection of the layers is important (handkerchief, napkin). where compression and thus the connection of the layers is important (handkerchief, napkin).

It is conceivable that the sleeve has a base body facing the roller core, which is made of steel or a non-ferrous metal. The base body can therefore be made of a more conventional material than the outside of the sleeve, to which the embossing sheet is attached. By using suitable materials for the base body, on the one hand, an optimal connection of the sleeve to the roller core can be achieved, and on the other hand, the sleeve can be manufactured more cost-effectively if only its outer side is made of an expensive, complex material.

The surface of the sleeve can have a plurality of contact edges and/or alignment pins by means of which the at least one embossing sheet is aligned on the sleeve. The contact edges can form an insertion opening that tapers towards the sleeve surface so that the embossing sheet can be applied to the sleeve in a self-centering manner. The insertion opening can surround the embossing sheet in a ring shape and at least in sections. The contact edges may extend substantially obliquely away from the sleeve surface, for example at an angle of greater than 95 degrees with respect to the sleeve surface. The roller surface can also have a grid of holes into which the dowel pins can be inserted to match the geometry of the embossing sheet.

The contact edges can be designed as elevations and/or depressions in the sleeve.

Furthermore, the sleeve and/or the embossing plate can have at least one alignment mark for determining a correct alignment of the embossing plate on the sleeve.

The alignment mark can have an opening in the embossing plate and a mark on the sleeve that is to be aligned with the opening. The opening and the marking may have the same characteristic shape, for example cross-shaped.

It can be provided that the embossing sheet comprises or consists of at least one of the following metals: steel, bimetal, nickel, copper.

Furthermore, it can be provided that the surface of the sleeve connected to the roller core has a concentricity of +/−2 μm, preferably +/−1.5 μm. It can further be provided that the embossing plate mounted on the sleeve also has a concentricity of +/−2 μm, preferably +/−1.5 μm. It is conceivable, for example, that a sleeve not used in the process is equipped with an embossing plate in parallel and pre-aligned on a measuring roller core, so that no or only minor measurements of the embossing plate are necessary when the sleeve is transferred to the arrangement. It may be intended that the sleeves are ground on manufacturing cores in a clamped state. It is conceivable that in order to fasten the sleeve to the roller core, the roller core can be expanded in the radial direction so that the sleeve is clamped onto the roller core.

It is conceivable that the embossed structure of the embossing sheet has embossed elevations and the embossing gap formed between the rollers is designed to produce a dot/dot embossing, an alternating embossing or a dot/surface embossing. The surface of the opposite roller opposite the embossed elevations can be provided, for example, by the roller surface itself or by a counter element provided on this surface, for example a suitably arranged embossing plate. At the beginning of the embossing process, the rollers can be aligned with each other so that the corresponding embossing structures, for example the opposing embossing sheets, are positioned opposite each other as intended.

It may be provided that the embossed elevations have punctual embossed stamps and/or embossed lines. The embossing stamps can have a substantially rectangular, square, round, oval or polygonal surface. In particular, the embossed lines can have a significantly greater length than their width. The embossed lines can be straight in sections and/or curved in sections and/or arranged to intersect themselves or each other.

It can be provided that the flanks of the embossed elevations are each perpendicular or oblique to the roller surface or concave. This means that the embossed elevations can have, for example, rectangular, square or trapezoidal cross-sections. When the flanks are formed in a concave shape, they can slope with a constant radius or in a hyperbolic shape from the top of the embossed elevations towards the sleeve surface.

It can be provided that the roller opposite the embossing plate has an elastic surface. The elastic roller surface can be realized, for example, by a printing blanket attached to it. It can be provided that the combination of embossing plate elevations and the elastic counter surface is designed to produce blind embossings by means of “debossing” embossing technology.

It is conceivable that the alternating embossing has an alternating dot/surface embossing, in which in adjacent embossing areas an anvil surface is arranged alternately opposite a plurality of pins. The anvil surface and the pins can each have a flat surface, wherein the surfaces are designed to roll against each other in the embossing gap to produce layer adhesion. The adjacent embossing areas can be spaced apart from one another, wherein free spaces can be provided between the embossing areas in which no contact between the tissue layers and one of the roller surfaces occurs. In the sense of the application, reciprocal means that each of the rollers involved has both sections with pins and sections with anvil surfaces, which are each arranged opposite the complementary elements of the counter roller.

In the free spaces, the roller surfaces of both rollers can be set back from a common rolling plane. The recesses thus present on both roller surfaces can be aligned or offset in relation to each other. Furthermore, the recesses can have different widths in the circumferential direction of the rollers.

In addition, it can be provided that both of the rollers each have a roller core and a sleeve detachably connected to the roller core, as well as at least one embossing plate detachably attached to the sleeve, wherein the embossing plate has an embossing structure, wherein the embossing plates are aligned with one another in the roller gap to produce a desired embossing.

The invention further relates to a method for operating an arrangement according to any one of the preceding claims, comprising the steps of:
Carrying out a first embossing process with an arrangement according to any one of the preceding claims;
Equipping at least one further sleeve located outside the arrangement with an embossing sheet, wherein the equipping takes place at least in sections parallel to carrying out the embossing process, and the equipping comprises the magnetic fastening of the embossing sheet to the sleeve;
Replacing at least one sleeve used in the arrangement with the at least one further sleeve, wherein replacing the used sleeve comprises releasing a frictional connection between the sleeve and a roller core and creating a frictional connection between the roller core and the at least one further sleeve;
Carrying out a second embossing process with the arrangement having the at least further sleeve.

The frictional connection can be created or released, for example, by expanding or contracting the roller core.

It can be provided that the first embossing process is carried out with an embossing sheet which has a first embossing structure and the second embossing process is carried out with an embossing sheet which has a second embossing structure.

Furthermore, it can be provided that the loading of the at least one further sleeve located outside the arrangement comprises the mounting and setting up of a second embossing plate on the sleeve.

Furthermore, the loading of the at least one further sleeve located outside the arrangement can further comprise the dismantling of a further embossing sheet from the sleeve.

Furthermore, replacing the at least one sleeve used in the arrangement with the at least one further sleeve may comprise:
Disconnecting the connection between the sleeve used in the arrangement and the roller core;
Removing the sleeve used in the arrangement from the roll core;
Aligning the at least one further sleeve on the roll core;
Attaching at least one additional sleeve to the roller core.

Further details of the invention are explained using the figures below. In the figures:

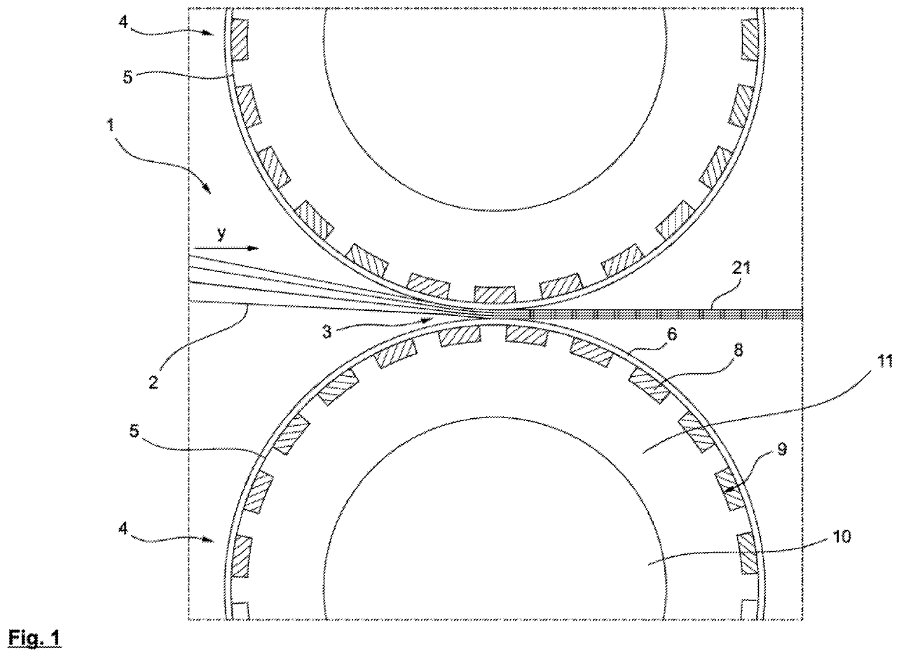

FIG. 1 an embodiment of a roller arrangement comprising two rollers each having a sleeve and an embossing plate;

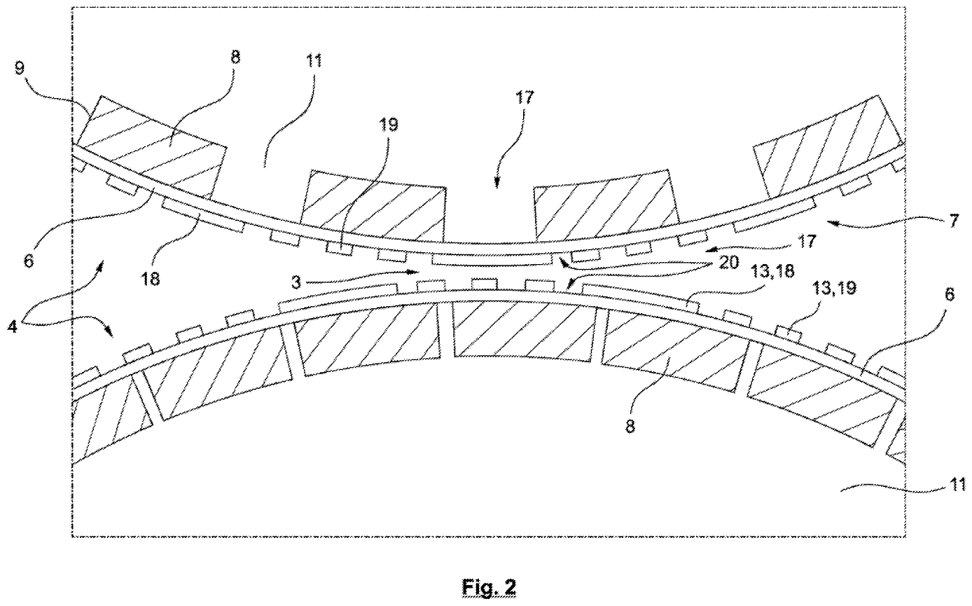

FIG. 2 an embodiment of a roller arrangement having an alternating embossing;

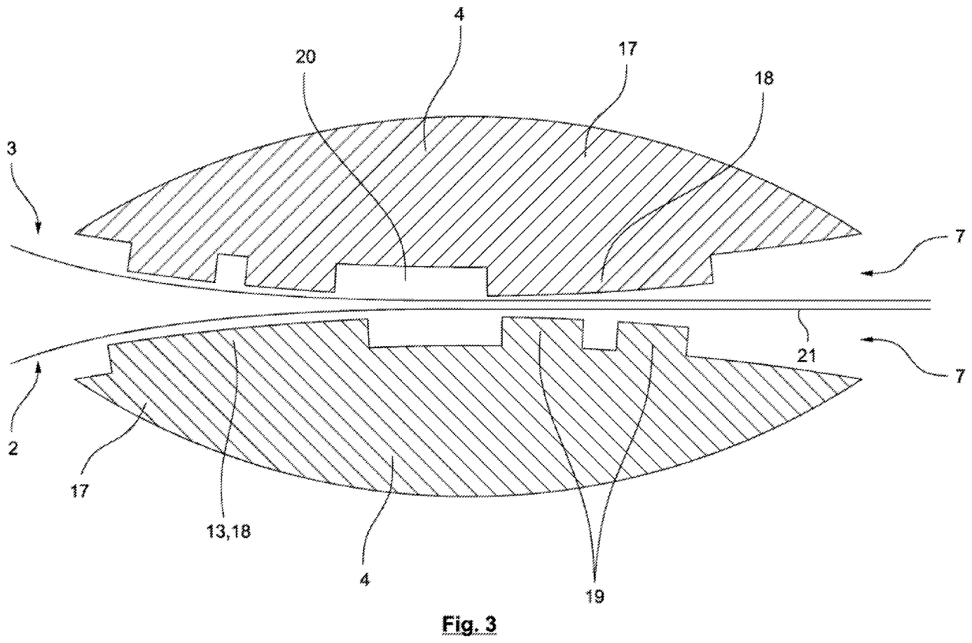

FIG. 3 a detailed view of a roller arrangement having an alternating embossing;

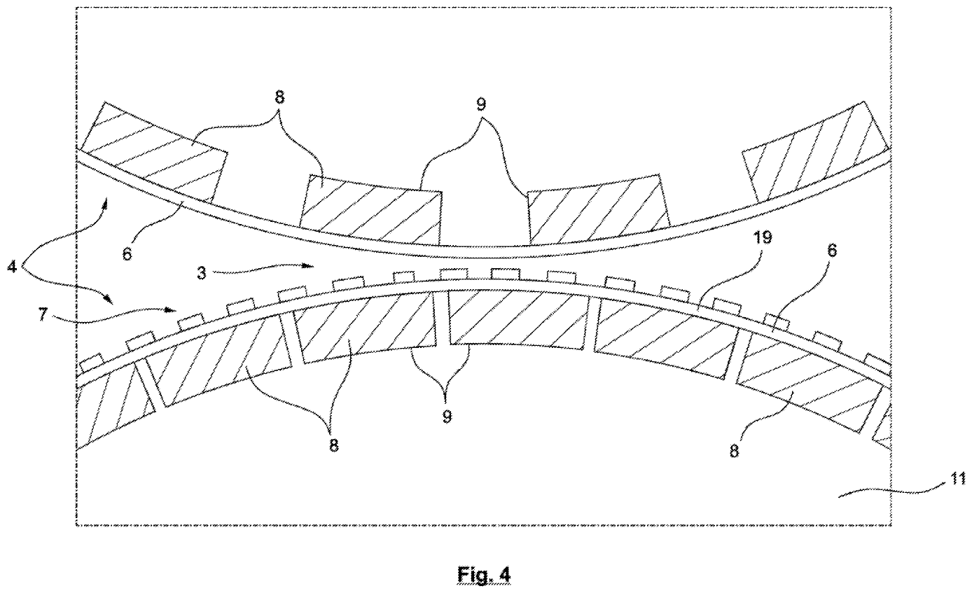

FIG. 4 an embodiment of a roller arrangement having a dot/smooth embossing;

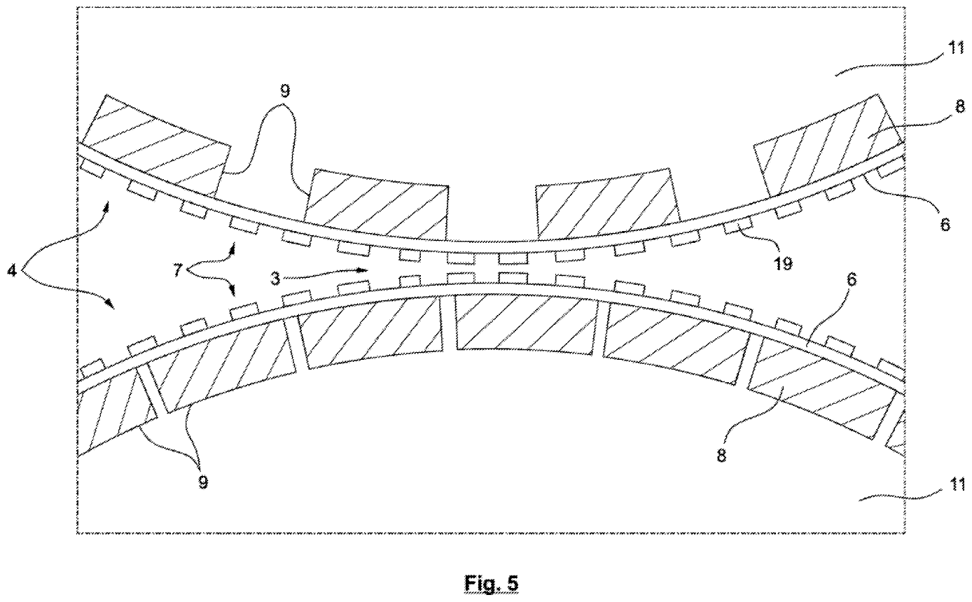

FIG. 5 an embodiment of a roller arrangement having a dot/smooth embossing;

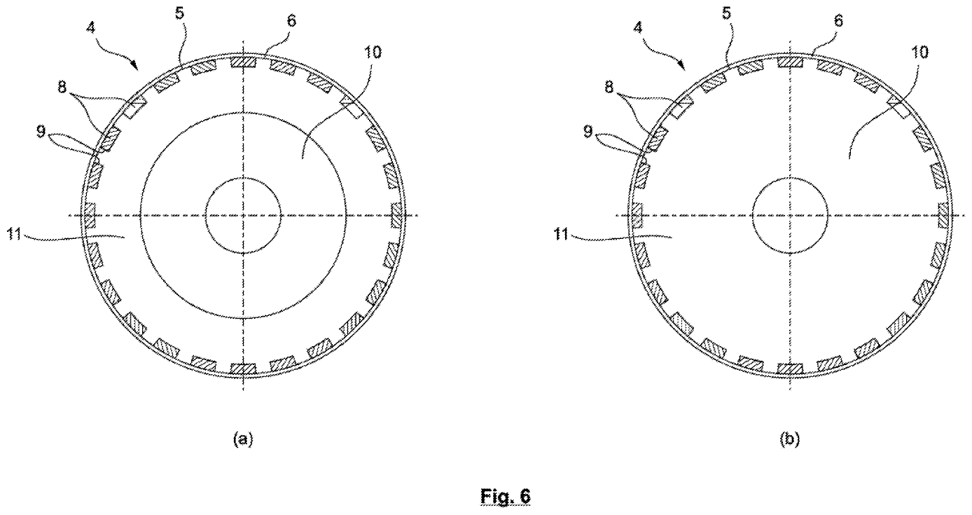

FIG. 6a)/b) cross-sectional views of a roller with embossing plate and a roller with sleeve and embossing plate; and

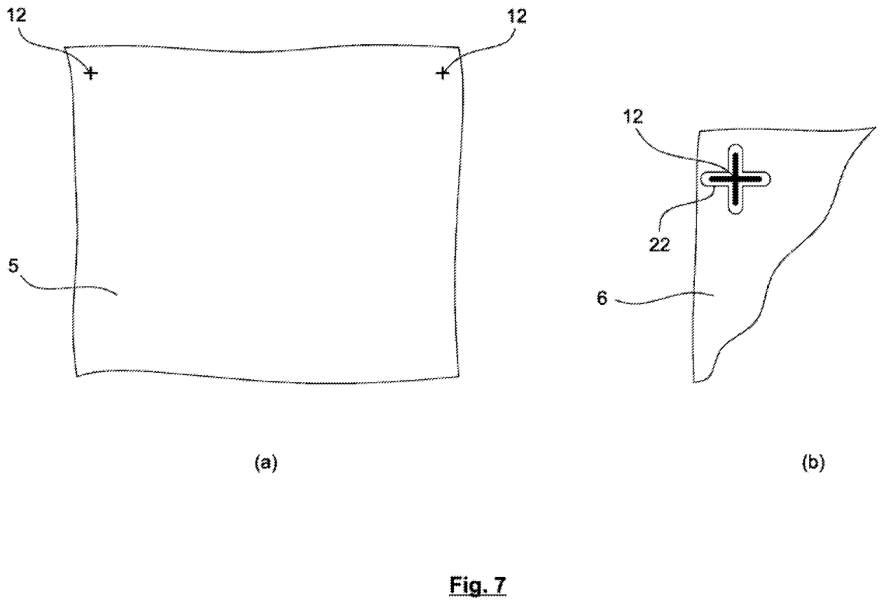

FIG. 7a)/b) an embodiment of coordinated alignment marks on the roller surface and the embossing plate.

FIG. 1 shows an embodiment of a roller arrangement 1 comprising two rollers 4, each having a sleeve 11 and an embossing plate 6. The rollers 4 each have an expander roller core 10, on which the sleeve 11 is clamped in a frictionally engaged manner. The outer sides of the sleeves 11 each have a plurality of grooves 9, in each of which a magnet 8 is accommodated. The grooves 9 or the magnets 8 accommodated therein extend essentially in the axial direction X of the rollers 4 and are regularly spaced from one another in the tangential direction and distributed over the entire circumference of the rollers. By means of the magnets 8, an embossing plate 6 is attached to the roller surface 5. The rollers 4 of the arrangement 1 form a roller gap 3, to which a plurality of unconnected tissue layers 2 are fed on the input side in a conveying direction Y, which leave the roller gap 3 on the output side in an embossed layer composite 21.

In FIG. 2 and FIG. 3 an embodiment of the arrangement 1 is shown, which has an alternating embossing 15. In this case, the embossing plates 6 have alternating embossing areas 17, in which one of the embossing plates 6 provides an anvil surface 18 and the other embossing plate 6 provides a plurality of pins 19, which are brought into contact with the anvil surface 18 in the embossing gap 3, so that the tissue layers 2 guided through the embossing gap are embossed between the pins 19 and the anvil surface 18. In the adjacent embossing areas 17, the embossing arrangement is then provided in the opposite manner, so that the anvil surface 18 and the pins 19 are arranged on the opposite embossing plates 6. This means that the embossing plate 6 of the upper roller 4 has embossing areas 17 with anvil surfaces 18 and embossing areas 17 with pins 19 in an alternating arrangement and the lower roller 4, in a manner complementary to the upper roller, also has embossing areas 17 with anvil surfaces 18 and embossing areas 17 with pins 19 in an alternating arrangement. Between the embossing areas 17, free spaces 20 are provided in which neither anvil surfaces 18 nor pins 19 are arranged, so that no embossing of the tissue layers 2 takes place in these areas.

FIG. 4 shows an exemplary embodiment in which the roller arrangement 1 has a dot/surface embossing 16. The upper of the illustrated rollers 4 has an embossing plate 6 which has a smooth surface, and the lower of the illustrated rollers 4 has an embossing plate 6 which has a dot embossing with a plurality of embossing pins 19. FIG. 5 shows a further exemplary embodiment in which the roller arrangement 1 has a dot/dot embossing 14. In this case, both the upper of the illustrated rollers 4 has an embossing plate 6 which has a dot embossing with a plurality of embossing pins 19, and the lower of the illustrated rollers 4 has an embossing plate 6 which has a dot embossing with a plurality of embossing pins 19. The rollers 4 are aligned to each other in such a way that the embossing pins 19 roll against each other in the roller gap 3.

FIG. 6 shows two different embodiments of a roller 4. The roller 4 shown in FIG. 6a) has a roller core 10, a sleeve 11 fastened thereto and an embossing plate 6 fastened to the sleeve 11 by means of a plurality of magnets 8 arranged in a plurality of grooves 9. In contrast, the roller 4 shown in FIG. 6b) has a roller core 10 and an embossing plate 6 mounted directly thereon, also fastened by means of a plurality of magnets 8 accommodated in a plurality of grooves 9. In the roller in FIG. 6a), the roller surface 5 is provided by the sleeve 11, whereas in the roller shown in FIG. 6b) it is provided by the roller core 10.

FIG. 7 shows how an embossing sheet 6 can be aligned on a roller surface 5. FIG. 7a) shows an example of a roller surface 5, either provided by a sleeve 11 or by the roller core 10, according to the explanations in FIG. 6. The roller surface 5 has two alignment marks 12, which are cross-shaped, for example, and can be realized, for example, by depressions, elevations or by color marking. As shown in FIG. 7b, the embossing plate 6 has cross-shaped openings 22 corresponding to the alignment marks 12, which are positioned in alignment with the alignment marks 12 for aligning the embossing plate 6, so that the alignment marks 12 are completely visible through the openings 22, thereby ensuring that the embossing plate 6 is correctly positioned on the roller surface 5.

The features of the invention disclosed in the above description, in the figures, and in the claims can be essential for the implementation of the invention both individually and in any combination.

### List Of Reference Numerals

1 arrangement
2 tissue layers
3 roller gap
4 roller
5 roller surface
6 embossing plate
7 embossing structure
8 magnets
9 grooves
10 roller core
11 sleeve
12 alignment mark
13 embossing elevations
14 dot/dot embossing
15 alternating embossing
16 dot/surface embossing
17 embossing area
18 anvil surface
19 pin
20 free space
21 layered composite
X axial direction
Y conveying direction

1. Arrangement for producing a layer adhesion of at least two tissue layers by means of cold welding, wherein the arrangement has two rollers forming an embossing gap for connecting the tissue layers, wherein at least one of the rollers has an embossing plate detachably fastened to the roller surface on its roller surface facing the embossing gap, wherein the embossing plate has an embossing structure, characterized in that the embossing plate is fastened to the roller by means of a plurality of magnets distributed over the roller surface and arranged at a distance from one another.

2. Arrangement according to claim 1, wherein the magnets are releasably received in grooves distributed over the circumference of the roller and spaced apart from one another.

3. Arrangement according to claim 2, wherein the grooves and the magnets received therein extend substantially in an axial direction (X) of the roller.

4. Arrangement according to claim 2, wherein the grooves are undercut and open into axial end faces of the roller body, so that the magnets can be mounted or dismounted in the grooves in the axial direction (X) of the roller.

5. Arrangement according to claim 1, wherein the magnets comprise a permanent magnetic material, for example iridine or neodymium, by means of which the at least one embossing sheet is attached to the roller surface.

6. Arrangement according to claim 1, wherein the at least one roller having the embossing sheet has a roller core and a sleeve detachably fastened to the roller core and enclosing it, so that the roller surface is provided by the sleeve.

7. Arrangement according to claim 6, in which the sleeve is connected to the roller core in a frictionally engaged manner, in particular by shrinking the sleeve and/or expanding the roller core, and the embossing sheet is fastened to the sleeve by the plurality of magnets distributed over the surface of the sleeve and arranged at a distance from one another.

8. Arrangement (1) according to claim 6, wherein the sleeve has a material thickness of >3 mm.

9. Arrangement according to claim 6, wherein the sleeve has a base body facing the roller core which is made of steel or a non-ferrous metal.

10. Arrangement according to claim 6, wherein the surface of the sleeve has a plurality of contact edges and/or alignment pins, by means of which the at least one embossing sheet is aligned on the sleeve.

11. Arrangement according to claim 10, wherein the contact edges are formed as elevations and/or depressions in the sleeve, which delimit an outer contour of the embossing sheet on the sleeve circumference at least in sections.

12. Arrangement according to claim 11, in which the contact edges have obtuse-angled bevels in relation to the sleeve surface, through which the boundary provided by the contact edges tapers in the direction of the sleeve so that the embossing plate can be mounted in a self-centering manner on the sleeve.

13. Arrangement according to claim 1, wherein the sleeve and/or the embossing plate has at least one alignment mark for determining a correct alignment of the embossing plate on the sleeve.

14. Arrangement according to claim 13, wherein the alignment mark has, on the one hand, an opening in the embossing plate and, on the other hand, a marking on the sleeve to be aligned with the opening wherein the opening and the marking have the same characteristic shape, for example cross-shaped.

15. Arrangement according to claim 1, wherein the embossing sheet comprises or consists of at least one of the following metals: steel, bimetal, nickel, copper.

16. Arrangement according to claim 1, wherein the surface of the sleeve connected to the roller core has a concentricity of +/−2 μm, preferably +/−1.5 μm.

17. Arrangement according to claim 1, wherein the embossed structure of the embossing sheet has embossed elevations and the embossing gap formed between the rollers is designed to produce a dot/dot embossing an alternating embossing or a dot/surface embossing.

18. Arrangement according to claim 17, wherein the embossed elevations have punctual embossing stamps and/or embossing lines and/or other geometric embossing shapes.

19. Arrangement according to claim 17, wherein the flanks of the embossed elevations are each perpendicular or oblique to the roller surface or concave.

20. Arrangement according to claim 1, wherein the roller opposite the embossing plate has an elastic surface.

21. Arrangement according to claim 17, wherein the alternating embossing has an alternating dot/surface embossing, in which in adjacent embossing areas an anvil surface is arranged alternately opposite a plurality of pins.

22. Arrangement according to claim 21, wherein the anvil surface and the pins each have a flat surface, wherein the surfaces are designed to roll on one another in the embossing gap to produce a layer adhesion.

23. Arrangement according to claim 16, wherein the adjacent embossed areas are spaced apart from one another, wherein free spaces are provided between the embossed areas, in which no contact of the tissue layers with one of the roller surfaces occurs.

24. Arrangement according to claim 23, wherein in the free spaces the roller surfaces of both rollers are set back from a common rolling plane.

25. Arrangement according to claim 1, wherein both of the rollers each have a roller core and a sleeve detachably connected to the roller core, and at least one embossing plate detachably attached to the sleeve, wherein the embossing plate has an embossing structure, wherein the embossing plates are aligned with one another in the roller gap to produce a desired embossing.

26. Method for operating an arrangement according to claim 1, comprising the steps of:
Carrying out a first embossing process with an arrangement according to claim 1;
Equipping at least one further sleeve located outside the arrangement with an embossing sheet, wherein the equipping takes place at least in sections parallel to carrying out the embossing process, and the equipping comprises the magnetic fastening of the embossing sheet to the sleeve;
Replacing at least one sleeve used in the arrangement with the at least one further sleeve, wherein replacing the used sleeve comprises releasing a frictional connection between the sleeve and a roller core and creating a frictional connection between the roller core and the at least one further sleeve;
Carrying out a second embossing process with the arrangement having the at least one further sleeve.

27. Method according to claim 26, wherein the frictional connection is created or released by expanding or contracting the roller core.

28. Method according to claim 26, wherein the first embossing process is carried out with an embossing sheet which has a first embossing structure and wherein the second embossing process is carried out with an embossing sheet which has a second embossing structure.

29. Method according to claim 26, wherein the loading of the at least one further sleeve located outside the arrangement comprises the mounting and setting up of a second embossing plate on the sleeve.

30. Method according to claim 29, wherein the loading of the at least one further sleeve located outside the arrangement further comprises the dismantling of a further embossing sheet from the sleeve.

31. Method according to claim 26, wherein replacing the at least one sleeve used in the arrangement with the at least one further sleeve comprises:
Disconnecting the connection between the sleeve used in the arrangement and the roller core;
Removing the sleeve used in the arrangement from the roll core;
Aligning the at least one further sleeve on the roll core;
Attaching at least one additional sleeve to the roller core.
